(19) United States
(12) Patent Application Publication
(10) Pub. No.: US 2023/0318942 A1
(43) Pub. Date: Oct. 5, 2023

(54) NETWORK DATA ANALYTIC FUNCTION NODE, NETWORK FUNCTION NODE, AND CONTROL METHOD THEREFOR

(71) Applicant: NEC Corporation, Minato-ku, Tokyo (JP)

(72) Inventors: Linghang FAN, Surrey (GB); Iskren IANEV, Reading (GB); Hassan AL-KANANI, Chinthurst (GB); Toshiyuki TAMURA, Tokyo (JP)

(73) Assignee: NEC Corporation, Minato-ku, Tokyo (JP)

(21) Appl. No.: 17/626,864

(22) PCT Filed: Jun. 24, 2021
(86) PCT No.: PCT/JP2021/024016

§ 371 Date: Jan. 13, 2022

(30) Foreign Application Priority Data
Jul. 22, 2020 (EP) 20187246.2

(51) Int. Cl. H04L 43/026

(52) U.S. Cl. CPC H04L 43/026

(57) ABSTRACT

A NWDAF node according to the present disclosure comprises means for receiving, from a network function node, a request for detecting a new application, including an indication having a value “new application analysis”, information for a UE, start and end time for detection and PFD information; means for subscribing, to a SMF node, data collection related to the new application; means for receiving, from a UPF node via the SMF node, the data related to the new application, including DNN, S-NSSAI, and 3-tuple(s); and means for notifying the network function node of an analytic result including the DNN, the S-NSSAI, the 3-tuple(s) to be added to the PFD information, parts of the URL to be matched, a Domain name matching criteria and information about applicable protocol(s), wherein the 3-tuple(s) includes a server side IP address and port number.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof. The disclosure has particular although not exclusive relevance to data analytics and application detection in the so-called ‘5G’ (or ‘Next Generation’) systems.

### Background Art

### Abbreviations and Terminology

3GPP 3rd Generation Partnership Project
5GC 5G Core Network
5GS 5G System
5G-AN 5G Access Network
ADC Application Detection and Control
AF Application Function
AMF Access and Mobility Management Function
AN Access Network
CC Country Code
DL Downlink
DNN Data Network Name
DNS Domain Name System
EIR Equipment Identity Register
FQDN Fully Qualified Domain Name
gNB Next Generation NodeB
GPS Global Positioning System
GPSI Generic Public Subscription Identifier
IMEI International Mobile Equipment Identity
IMEI SV International Mobile Equipment Identity Software Version
IMSI International Mobile Subscriber Identity
IP Internet Protocol
MCC Mobile Country Code
MM Mobility Management
MT Machine Terminated
MNC Mobile Network Code
MNO Mobile Network Operator
MSISDN Mobile Station International Subscriber Directory Number
NAI Network Access Identifier
NAS Non-Access-Stratum
NEF Network Exposure Function
NF Network Function
NG Next Generation
NG-RAN Next Generation-Radio Access Network
NR New Radio
NRF Network Repository Function
NSSAI Network Slice Selection Assistance Information
NWDAF Network Data Analytics Function
OAM Operations, Administration and Maintenance
OS Operating System
OTA Over the Air
OTT Over the Top
PCC Policy and Charging Control
PCF Policy Control Function
PDB Packet Delay Budget
PDU Protocol Data Unit
PDR Packet Detection Rule
PFD Packet Flow Description
PEI Permanent Equipment Identifier
PER Packet Error Rate
PLMN Public Land Mobile Network
RAN Radio Access Network
RAT Radio Access Technologies
RRC Radio Resource Control
SBA Service-based Architecture
SM Session Management
SMF Session Management Function
SMS Short Message Service
S-NSSAI Single Network Slice Selection Assistance Information
SUPI Subscription Permanent Identifier
UE User Equipment
UDM Unified Data Management
UDR User Data Repository
UPF User Plane Function
UL Uplink
URL Uniform Resource Locator
URR Usage Reporting Rule

### Definitions

For the purposes of the present document, the terms and definitions given in 3GPP Technical Report (TR) 21.905 (NPL 1) and the following apply. A term defined in the present document takes precedence over the definition of the same term, if any, in 3GPP TR 21.905 (NPL 1).

### Background

The 3GPP Working Groups are currently defining the 5G system and the 3GPP TSG SA WG2 (SA2) is specifying the 5G system architecture in 3GPP Technical Specification (TS) 23.501 (NPL 2) and procedures in 3GPP TS 23.502 (NPL 3). In order to provide network data analytics in 5G networks, a Network Function (NF) called Network Data Analytics Function (NWDAF) is being specified by SA2 in 3GPP TS 23.288 (NPL 5)

Recently, a new study has been proposed in SA2 to identify new type of outputs provided by the NWDAF for new use cases. The 3GPP TR 23.700-91 (NPL 6) captures the latest results of this study.

### CITATION LIST

### Non Patent Literature

NPL 1: 3GPP TR 21.905: “Vocabulary for 3GPP Specifications”. V17.0.0 (2020-07)
NPL 2: 3GPP TS 23.501: “System architecture for the 5G System (5SG)”. V16.5.0 (2020-07)
NPL 3: 3GPP TS 23.502: “Procedures for the 5G System (5G5)”. V16.5.0 (2020-07)
NPL 4: 3GPP TS 23.503: “Policy and charging control framework for the 5G System (5GS); Stage 2”. V16.5.0 (2020-07)
NPL 5: 3GPP TS 23.288: “Architecture enhancements for 5G System (5GS) to support network data analytics services”. V16.4.0 (2020-07)
NPL 6: 3GPP TR 23.700-91: “Study on enablers for network automation for the 5G System (5GS); Phase 2”. V0.4.0 (2020-06)
NPL 7: 3GPP TS 29.244: “Interface between the Control Plane and the User Plane Nodes; Stage 3”. V16.4.0 (2020-06)
NPL 8: IETF RFC RFC5580 “Carrying Location Objects in RADIUS and Diameter” https://tools.ietf.org/html/rfc5580

### SUMMARY OF INVENTION

### Technical Problem

### Problem Description

The number of applications or services available in the market is continuously growing, and the speed of new application release is also increasing very rapidly. It will be slow and expensive to detect and manage all applications using manually provisioned rules.

In order to detect newly released applications, the NWDAF should collect all necessary data from a data plane node to perform data analysis in accordance with current role of the NWDAF in the 3GPP system. For example, target user data should be transferred from user data handling entities, e.g. a UPF or a RAN, to the NWDAF to detect traffic characteristics and to provide a new analysis for application detection information.

However, this approach does not seem feasible. Firstly, the NWDAF is designed as a control signalling node and thus user data should not be handled. Secondly, a massive number of user data has to be conveyed within 5GC and this has cost impact to the 5GC.

An efficient mechanism, while keeping basic functional assignment to each 3GPP logical node, is needed to automate application detection.

### Solution to Problem

A network data analytic function, NWDAF, node according to one aspect, comprising:
means for receiving, from a network function node, a request for detecting a new application, including an indication having a value “new application analysis”, information for a User Equipment, UE, start and end time for detection and Packet Flow Description, PFD, information;
means for subscribing, to a session management function, SMF, node, data collection related to the new application;
means for receiving, from a user plane function, UPF, node via the SMF node, the data related to the new application, including data network name, DNN, single-network slice selection assistance information, S-NSSAI, and 3-tuple(s); and
means for notifying the network function node of an analytic result including the DNN, the S-NSSAI, the 3-tuple(s) to be added to the PFD information, parts of the Unified Resource Locator, URL, to be matched, a Domain name matching criteria and information about applicable protocol(s), wherein
the 3-tuple(s) includes a server side Internet Protocol, IP, address and port number.

A network function node according to another aspect, comprising:
means for transmitting, to a network data analytic function, NWDAF, node, a request for detecting a new application, including an indication having a value “new application analysis”, information for a User Equipment, UE, start and end time for detection and Packet Flow Description, PFD, information;
means for receiving, from the NWDAF node, an analytic result including DNN, S-NSSAI, 3-tuple(s) to be added to the PFD information, parts of the Unified Resource Locator, URL, to be matched, a Domain name matching criteria and information about applicable protocol(s), wherein
the 3-tuple(s) includes a server side Internet Protocol, IP, address and port number, and
data related to the new application including the DNN, the S-NSSAI and the 3-tuple(s) is sent from a user plane function, UPF, node via a session management function, SMF, node, upon subscription of data collection related to the new application from the NWDAF node to the SMF node.

A control method for a network data analytic function, NWDAF, node according to another aspect, comprising:
receiving, from a network function node, a request for detecting a new application, including an indication having a value “new application analysis”, information for a User Equipment, UE, start and end time for detection and Packet Flow Description, PFD, information;
subscribing, to a session management function, SMF, node, data collection related to the new application;
receiving, from a user plane function, UPF, node via the SMF node, the data related to the new application, including data network name, DNN, single-network slice selection assistance information, S-NSSAI, and 3-tuple(s); and
notifying the network function node of an analytic result including the DNN, the S-NSSAI, the 3-tuple(s) to be added to the PFD information, parts of the Unified Resource Locator, URL, to be matched, a Domain name matching criteria and information about applicable protocol(s), wherein
the 3-tuple(s) includes a server side Internet Protocol, IP, address and port number.

A control method for a network function node according to another aspect, comprising:
transmitting, to a network data analytic function, NWDAF, node, a request for detecting a new application, including an indication having a value “new application analysis”, information for a User Equipment, UE, start and end time for detection and Packet Flow Description, PFD, information; and
receiving, from the NWDAF node, an analytic result including DNN, S-NSSAI, 3-tuple(s) to be added to the PFD information, parts of the Unified Resource Locator, URL, to be matched, a Domain name matching criteria and information about applicable protocol(s), wherein
the 3-tuple(s) includes a server side Internet Protocol, IP, address and port number, and
data related to the new application including the DNN, the S-NSSAI and the 3-tuple(s) is sent from a user plane function, UPF, node via a session management function, SMF, node, upon subscription of data collection related to the new application from the NWDAF node to the SMF node.

### Advantageous Effects of Invention

The above aspects can contribute to solve the above problem.

### BRIEF DESCRIPTION OF DRAWINGS

FIG. 1 is a timing (signaling) diagram schematically illustrating an exemplary procedure for new application detection with NWDAF defining ADC rule.

FIG. 2 is a timing (signaling) diagram schematically illustrating an exemplary procedure for new application detection with NWDAF defining ADC rule.

FIG. 3 is a timing (signaling) diagram schematically illustrating an exemplary procedure for a PCF defining Application Detection related PCC Rules.

FIG. 4 is a timing (signaling) diagram schematically illustrating an exemplary procedure for a PCF defining Application Detection related PCC Rules.

FIG. 5 is a diagram schematically illustrating a mobile (cellular or wireless) telecommunication system to which the present aspect is applicable.

FIG. 6 is a block diagram illustrating the main components of the UE (mobile device) shown in FIG. 5.

FIG. 7 is a block diagram illustrating the main components of an exemplary (R)AN node (base station) shown in FIG. 5

FIG. 8 is a block diagram illustrating the main components of a generic core network node (or function) shown in FIG. 5.

### DESCRIPTION OF EMBODIMENTS

### Detailed Description

In order to address at least one of the aforementioned problems, the present disclosure describes two solutions:
Solution 1: A NWDAF 11 defines an Application Detection and Control (ADC) rule for new application detection, which provides flexibility to the operator to detect any specific application, without requiring additional resource for user data handling.
Solution 2: A PCF 12 defines Application Detection related PCC Rules, which take advantages of reverse DNS lookup, which is a DNS technique that determines the domain name from an IP address. The NWDAF 11 can obtain an URL and domain name information of a packet from an IP address provided in a non-matching header packet report, which reports packets in a default QoS flow that cannot match any packet filter or any PFD in packet detection rules. Therefore, the UPF 10 doesn't need to send the NWDAF 11 whole user data in order to extract the URL and the domain name from the user data.

Note that the term “user data” in this document can be interpreted as “user packets”, “application data” or “application packets”.

<Solution 1: A NWDAF 11 Defines an ADC Rule for New Application Detection>

The main idea of this solution is that the NEF 14 requests the NWDAF 11 to perform data analytics on new application detection with searching requirements. The NWDAF 11 generates an application detection and control (ADC) rule, which passes to a PCF 12. The PCF 12 generates new PCC rules, which are used by an UPF 10 to detect new application, and reports them to the NWDAF 11. The NWDAF 11 performs data analytics and notifies subscribed consumers (e.g. the NEF 14) of its analytics results.

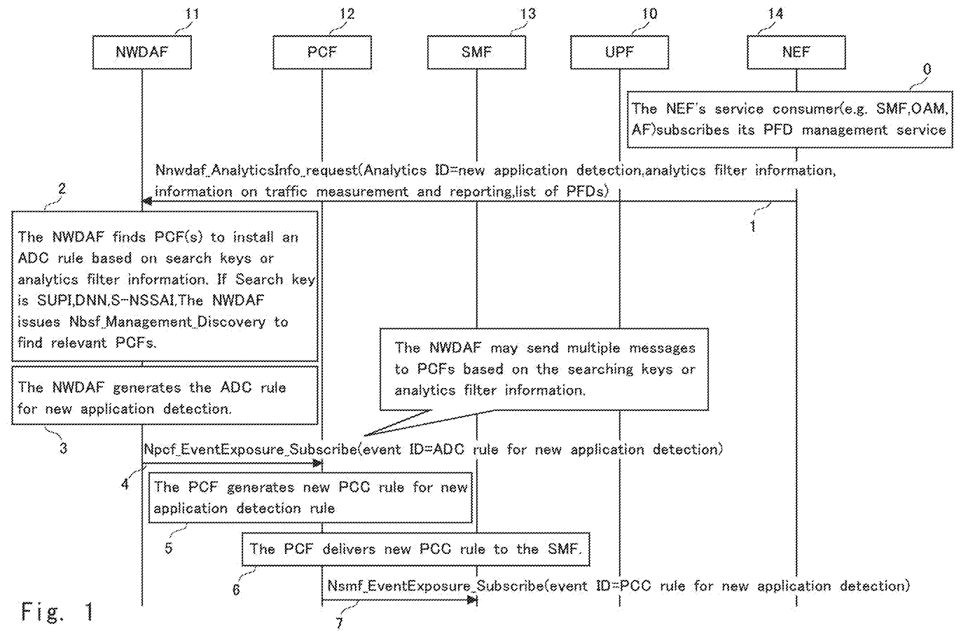

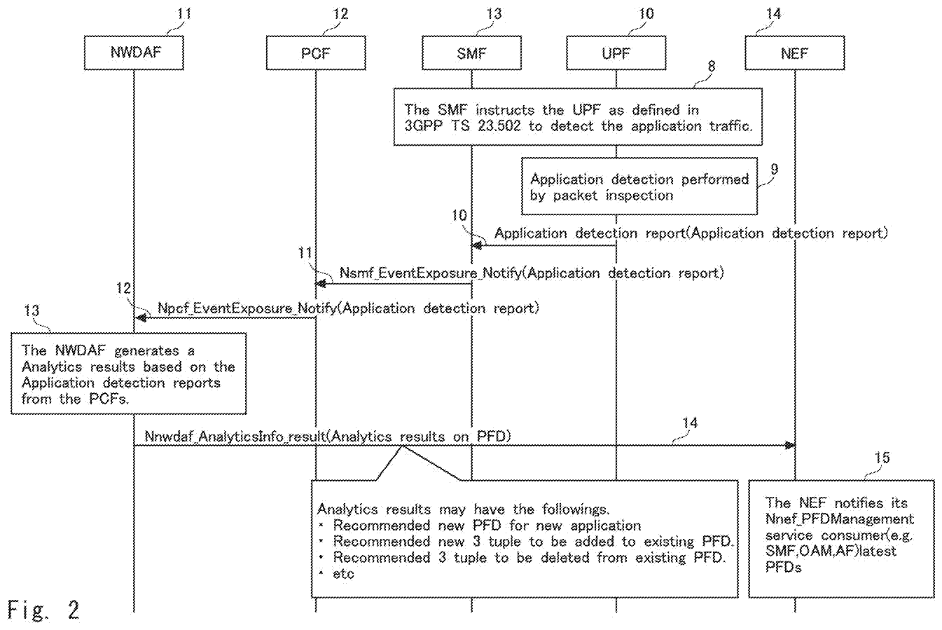

FIGS. 1 and 2 illustrate schematically a timing (signaling) diagram for an exemplary procedure for new application detection with NWDAF 11 defining ADC rule, in which:

Step 0: The NEF 14's service consumer (e.g. SMF, OAM, AF) subscribes its PFD management service.

Step 1: In order to obtain the analytics information on new application detection, the NWDAF consumer (e.g. NEF 14) invokes an analytics information request procedure or any other relevant procedure or sends an “Nnwdaf_Analyticslnfo_request” message or any other relevant message to the NWDAF 11 for requesting new application detection analytics information report or notification from the NWDAF 11.

The service consumer can be the NEF 14.

This message from the NWDAF service consumer to the NWDAF 11 includes an analytics ID, analytics filter information, information on traffic measurement and reporting, list of PFDs, target of Analytics Reporting, and Analytics target period. The parameters, such as analytics filter information, information on traffic measurement and reporting and list of PFDs can be sent to the NWDAF 11 in a separated message.

Analytics ID(s) identify the requested analytics as described in 3GPP TS 23.288 (NPL 5). In this solution, the analytics ID is used to identify the analysis on new application detection. The Analytic ID may have a new value “new application detection” and/or the like.

In this disclosure, Analytics Filter Information indicates the conditions to be fulfilled for reporting analytics information, and it enables to select which type of analytics information is requested (e.g. subset of all available analytics produced by the NWDAF 11 for the given Analytics ID) as described in 3GPP TS 23.288 (NPL 5). The exemplary of analytics filter information is as follows:
UE (GPSI/SUPI), or List of UEs
Home subscriber, visited subscriber, or visited subscriber with specific MCC and MNC.
Area of interest. Information indicating the area can include at least one of cell ID, list of cell ID, Tracking area, list of tracking area, or location object as defined in IETF RFC RFC5580 (NPL 8)
Access type, e.g. 3GPP access and/or non-3GPP access
RAT type, e.g. NR, NB-IOT, Untrusted Non-3GPP, Trusted Non-3GPP, Trusted IEEE 802.11 Non-3GPP access, Wireline, Wireline-Cable, Wireline-BBF.
UPF address, or a list of UPF addresses
The number of sample PDU sessions to inspect
A combination of information listed above.

The analytics filter information can be called as search key(s).

The information on traffic measurement and reporting indicates a target traffic to be measured at the UPF 10. In addition, measurement duration, measurement threshold, report format, etc. can also be specified. The exemplary of the information on traffic measurement and reporting is as follows:
A destination IPv4 address or a range of destination IPv4 addresses
A destination IPv6 address or a range of destination IPv6 addresses
An application-identifier with wildcard or a list of application-identifier with wildcard (e.g. its value may represent an application, such as a URL, FQDN, etc.)
DNN, S-NSSAI, DNN and S-NSSAI combination, a list of DNN, a list of S-NSSAI, a list of DNN and S-NSSAI combination
Measurement threshold
   Measurement duration
   Volume of measured user data
   The number of identified target traffic
Report format
   Volume of UL/DL packets of identified target traffic per a specified period.

For example, if a URL is designated for packet search and such URL is assigned to a video content server, then total UL/DL packet counts for video traffic is reported per specified period.
The packet count of identified target traffic per a specified period.

For example, if a URL is designated for packet search, then the number of occurrence on matching the URL is reported per specified period. Typically the URL matching can be found in a traffic for DNS query by the user.
A combination of information listed above.

The information on traffic measurement and reporting can be called as search condition(s).

The list of PFDs is the full set of the latest PFDs that are available at the network. The list of PFDs is used in the NWDAF 11 in the step 13 to identify whether a reported traffic is existing one or new.

The target of Analytics Reporting indicates the object(s) for which Analytics information is requested. For example, the object(s) can be specific UEs, a group of UE(s) or all UEs as described in 3GPP TS 23.288 (NPL 5). GPSI and SUPI can be used in the target of Analytics Reporting.

Analytics target period is a specified time interval from the start time to the end time as described in 3GPP TS 23.288 (NPL 5).

Step 2: The NWDAF 11 finds the relevant PCF(s) 12 to send an ADC rule based on search keys or on the analytics filter information. If the search key or the analytics filter information includes a SUPI, a DNN, or a S-NSSAI, the NWDAF 11 issues Nbsf_Management_Discovery to find relevant PCFs 12.

The NWDAF 11 can also find the relevant PCFs 12 via a NRF, by invoking an Nnrf_NFDiscovery_Request service with the preferred target NF location or the TAI derived from area of interests as described in 3GPP TS 23.502 (NPL 3).

Step 3: The NWDAF 11 generates the ADC rule for new application detection. The ADC rule is generated based on analytics ID, search condition(s) or the information on traffic measurement and reporting. The ADC rules have the rule on application detection, and the rule on measurement and reporting.

Step 4: In order to collect the information on new application, the NWDAF 11 invokes the new application detection information subscription procedure or any other relevant procedure or sends an “Npcf_EventExposure_Subscribe” message or any other message to the related PCF(s) 12 for subscribing new application detection related data from the related PCF(s) 12. The NWDAF 11 may send multiple messages to the PCFs 12 based on the searching keys or analytics filter information. The “Npcf_EventExposure_Subscribe” message or any other message to the related PCF(s) 12 for subscribing new application detection related data from the related PCF(s) 12 may include the generated ADC rules for installing the ADC rules to PCF(s) 12.

This message includes event ID(s), event filter(s), the target of event reporting, a Notification Target Address (+Notification Correlation ID), Event target period, Event reporting mode, DNN, and NSSAI. The event ID may include a new value “ADC rule for new application detection”.

An Event ID identifies the type of event being subscribed to (e.g. PDU Session release) as described in 3GPP TS 23.502 (NPL 3). In this message, the event ID identifies the type of event related to the ADC rule for new application detection.

An Event filter indicates the condition to be fulfilled for notifying the subscribed Event ID, and includes event related parameter(s) and their value(s) to be matched against. The Event Filter depends on the Event ID as described in 3GPP TS 23.502 (NPL 3).

The target of event reporting indicates a specific UE or a group of UE(s) or all UEs as described in 3GPP TS 23.502 (NPL 3). GPSI and SUPI can be used to indicate the specific UE in the target of event Reporting.

The target of event reporting can be the same as the target of analytics reporting.

A Notification Target Address (+Notification Correlation ID) allows it to correlate notifications received from the Event provider with the service consumer's subscription as described in 3GPP TS 23.502 (NPL 3).

Analytics target period is a specified time interval from the start time to the end time.

Event reporting mode is the mode of event reporting. For example, it can report event-by-event, of reporting up to a maximum number of reports, or periodic reporting, or reporting up to a maximum duration as described in 3GPP TS 23.502 (NPL 3).

Step 5: The PCF 12 stores the ADC rules received from the NWDAF 11. Based on the ADC rules, the PCF 12 updates existing PCC rules to add new application detection and control function. These new rules are on packet detection and usage information collection and reporting, and the purpose of these PCC rules is to detect the new applications, and measure and report the detected new applications. The usage information collection and reporting includes usage information reporting criteria and usage information measurement. The added new rules may include information a new packet detection rule and a new usage reporting rule. The new packet detection rule may include information for at least one on packet filter and PFD(s). The new usage reporting rule may include information for a reporting criterion (or criteria).

Step 6: The PCF 12 delivers new PCC rules to the SMF 13 as described in 3GPP TS23.502 (NPL 3).

Step 7: The PCF 12 invokes a new application detection procedure or any other relevant procedure or sending the SMF 13 an Nsmf_EventExposure_Subscribe message to subscribe the data related to new application detection. The new application detection related data are detected, measured and reported under the new PCC rules for new application detection.

Step 6 and Step 7 can be performed in one single step.

Step 8: Based on the new PCC rules for new application detection received from the PCF 12, the SMF 13 generates a new packet detection rule and a new usage reporting rule, and instructs the UPF 10 using the N4 Session Modification procedure as described in TS23.502 (NPL 3) to detect, measure and report the application traffic by using the new packet detection rule and the new usage reporting rule. The new packet detection rule may include information for at least one on packet filter and PFD(s). The new usage reporting rule may include information for a reporting criterion (or criteria).

Step 9: The UPF 10 performs packet inspection in order to detect, measure, and report the new application traffic under the new packet detection rule and the new usage reporting rule received at Step 8. If a packet in the default QoS flow cannot match any packet filter or any PFD in the new packet detection rules, it is detected, measured and reported by the UPF 10.

Step 10: When the reporting criteria indicated by the new usage reporting rule received at Step 8, is met, the UPF 10 sends an application detection report to the SMF 13.

This application detection report lists the packets that don't have an application ID and cannot match any packet filter in default QoS flow in packet detection rules.

For each detected packet, this application detection report includes at least one of the following parameters: DNN, S-NSSAI, 3-tuple(s), Destination FQDN. 3-tuple(s) includes the protocol ID of the protocol above IP, the destination IP address and the destination port number.

Step 11: The SMF 13 sends the PCF 12 the Nsmf_EventExposure_Notify message or any other relevant message to report the application detection report received from the UPF 10.

Step 12: The PCF 12 forwards the NWDAF 11 the Npcf_EventExposure_Notify message or any other message to report the application detection report received from the SMF 13.

Step 13: Based on the application detection report received from the PCF 12, the NWDAF 11 performs data analysis and generates analytics results on new application detection.

The analytics results on new application detection include at least one of the following parameters: DNN, S-NSSAI, the list of recommended new PFDs for new applications, the list of recommended new 3-tuple to be added to existing PFDs, and the list of recommended 3-tuple to be deleted from existing PFDs.

The list of recommended new PFDs for new applications includes at least one of the following parameters: 3-tuple(s) including protocol, server side IP address and port number; the significant parts of the URL to be matched, a Domain name matching criteria and information about applicable protocol(s).

The list of recommended new 3-tuple to be added to existing PFDs includes at least one of the following parameters: 3-tuple(s) including protocol, server side IP address and port number; the significant parts of the URL to be matched, a Domain name matching criteria and information about applicable protocol(s).

The list of recommended 3-tuple to be deleted from existing PFDs includes at least one of the following parameters: 3-tuple(s) including protocol, server side IP address and port number; the significant parts of the URL to be matched, a Domain name matching criteria and information about applicable protocol(s).

Step 14: Based on the results from data analytics, the NWDAF 11 notifies the relevant service consumer(s) of the analytics result(s) by invoking a new application detection notification procedure or any other relevant procedure or sends the Nnwdaf_AnalyticsInfo_Notify message or any other message to the relevant service consumer (e.g. NEF 14) in order to report/notify analytics results on new application detection. This message includes Notification Correlation Information, and the analytics results on new application detection.

Analytics results may have the followings information.
Recommended new PFD for new application
Recommended new 3-tuple to be added to existing PFD.
Recommended 3-tuple to be deleted from existing PFD.

Notification Correlation Information is a Notification Target Address (+Notification Correlation ID) that allows correlating notifications received from the NWDAF 11 with the service consumer' subscription as described in 3GPP TS 23.288 (NPL 5). Notification Correlation Information can be used instead of analytics ID(s) and analytics filter(s), which are optional parameters in the above message.

Step 15: The NEF 14 notifies its Nnef_PFDManagement service consumer of the list of latest PFDs, which is updated based on NWDAF 11's analytics results on new application detection.

The service consumer can be the SMF 13, the OAM, and the AF.

<Solution 2 PCF 12 Defines Application Detection Rules>

The main idea of this solution is that the PCF 12 delivers new application detection related PCC rules to the SMF 13. The NEF 14 subscribes NWDAF 11's service to detect new applications, and the NWDAF 11 subscribes SMF 13's report on packets from new application traffic. The SMF 13 instructs UPF 10 to report packets that don't have an application ID and cannot match any packet filter in default QoS flow in PDR and URR. The UPF 10 performs packet inspection and reports the new application packets. The NWDAF 11 analyses the non-matching packet header report and produces lists of corresponding PFD IDs, and provides the lists of corresponding PFDs to the NEF 14. The NEF 14 assigns an official PFD ID for each new PFD and allocates an application ID for the new PFD, and sends the SMF 13 the lists of PFD IDs with corresponding application IDs. The SMF 13 sends the UPF 10 the updated PDRs for application detection.

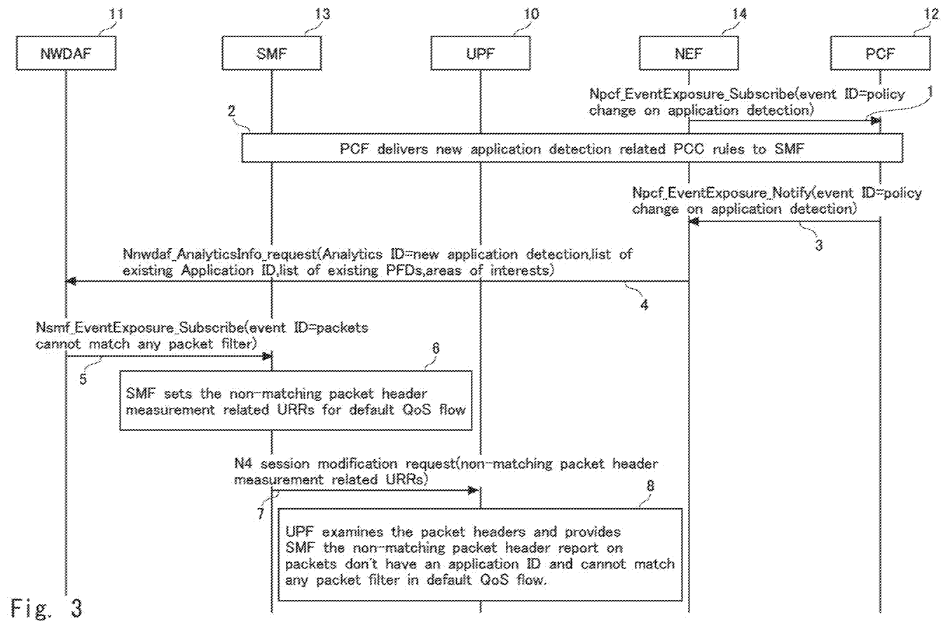

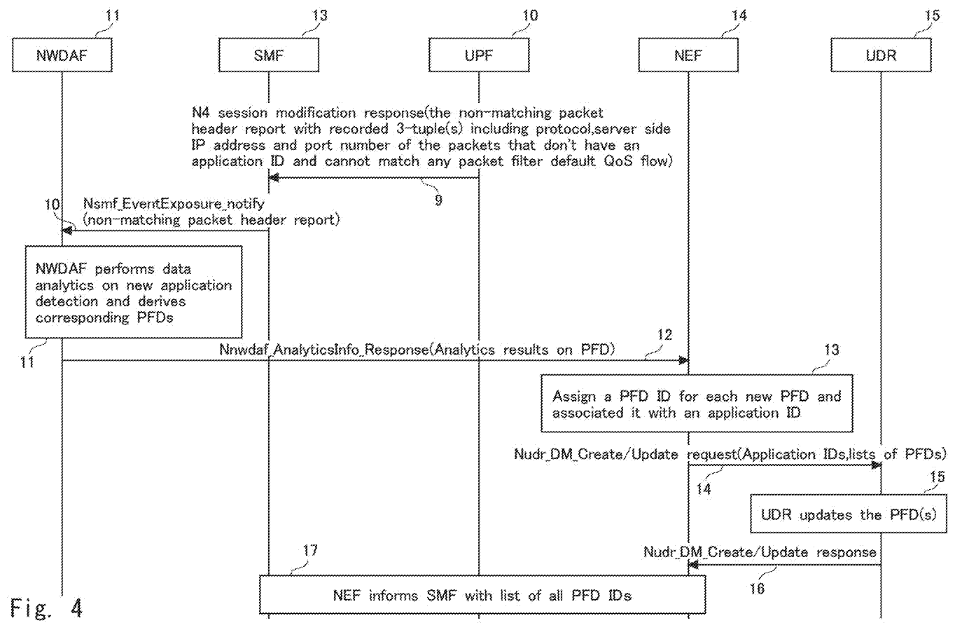

FIGS. 3 and 4 illustrate schematically a timing (signaling) diagram for an exemplary procedure for a PCF 12 defining Application Detection related PCC Rules, in which:

Step 1: The NEF 14 invokes event subscription procedure or any other procedure or sends the “Npcf_EventExposure_Subscribe” message or any other message to the PCF 12 for subscribing policy change on application detection including the event ID having a new value “policy change on application detection”.

Step 2: The PCF 12, in response to the new event ID, delivers new application detection related PCC rules to the SMF 13 by using a similar procedure described in TS23.502 (NPL 3) and TS23.503 (NPL 4). The new application detection related PCC rules are on packet detection and usage information collection and reporting, and the purposes of these PCC rules are to detect the new applications packets that don't have an application ID and cannot match any packet filter in default QoS flow, and to measure and report the detected new applications. The usage information collection and reporting includes usage information reporting criteria and usage information measurement.

Step 3: The PCF 12 notifies the NEF 14 the policy change on application detection via an Npcf_EventExposure_Notify message including event ID having the new value “policy change on application detection”.

Step 4: In order to obtain the analytics information on new application detection, the NWDAF consumer (e.g. NEF 14) invokes an analytics information request procedure or any other procedure or sends the “Nnwdaf_Analyticslnfo_request” message or any other message to the NWDAF 11 for requesting new application detection analytics information report or notification from the NWDAF 11.

The consumer can be the NEF 14.

This message includes an analytics ID, list of existing Application ID, list of existing PFDs, areas of interests, Analytics Filter Information, the target of Analytics Reporting, and Analytics target period.

Analytics ID(s) identify the requested analytics as described in 3GPP TS 23.288 (NPL 5). The analytics ID is used to identify the analysis on new application detection. The Analytics ID may have a new value “new application detection” and/or the like.

Analytics Filter Information indicates the conditions to be fulfilled for reporting analytics information, and it enables to select which type of analytics information is requested (e.g. subset of all available analytics produced by NWDAF 11 for the given Analytics ID) as described in 3GPP TS 23.288 (NPL 5).

The list of existing Application ID is the full set of applications that are known to the network. The list of existing PFDs is used in the UPF 10 to identify whether an inspected packet is from a known application or from a new application.

The list of existing PFDs is the full set of latest PFDs that are available at the network. The list of existing PFDs is used in the NWDAF 11 to identify whether a reported traffic is existing one or new.

The target of Analytics Reporting indicates the object(s) for which Analytics information is requested. For example, the object(s) can be specific UEs, a group of UE(s) or any UE (i.e. all UEs) as described in 3GPP TS 23.288 (NPL 5). GPSI and SUPI can be used in the target of Analytics Reporting.

Analytics target period is a specified time interval from the start time to the end time.

Step 5: The NWDAF 11 invokes a new application detection procedure or any other procedure or sending the SMF 13 an Nsmf_EventExposure_Subscribe message or any other message to subscribe the data related to new application detection. The new application detection related data are detected, measured and reported under the new PCC rules for new application detection. The message may include an event ID having a new value “packets cannot match any packet filter”.

Step 6: Based on the new application detection related PCC rules received from the PCF 12 at Step 2 and received the new event ID at Step 5, the SMF 13 generates a new packet detection rule and a new usage reporting rule, and instructs the UPF 10 as per described in 3GPP TS 23.503 (NPL 4) and 3GPP TS 29.244 (NPL 7) to detect, measure and report the application traffic.

Step 7: The SMF 13 sends the UPF 10 a N4 session modification request message or any other message to deliver usage report rule for new application detection (i.e. (non-matching packet header) measurement and reporting.

Step 8: The UPF 10 performs packet inspection in order to examine the packet headers, and to detect, measure, and report the new application traffic under the new packet detection rule and the new usage reporting rule. If a packet doesn't have an application ID and cannot match any packet filter in default QoS flow in packet detection rules, it is detected, measured and reported.

Step 9: When the reporting criteria is met, the UPF 10 sends the non-matching packet header report to the SMF 13. The non-matching packet header report can be called the application detection report, and its purpose is to report the packets don't have an application ID and cannot match any packet filter in default QoS flow in packet detection rules.

This report includes at least one of the following parameters of the detected packet: DNN, S-NSSAI, 3-tuple(s), Destination FQDN. 3-tuple(s) includes the protocol ID of the protocol above IP, the destination IP address and the destination port number.

Step 10: The SMF 13 sends the NWDAF 11 the Nsmf_EventExposure_Notify message or any other message to report the non-matching packet header report received from the UPF 10.

Step 11: Based on the application detection report received from the SMF 13, the NWDAF 11 performs data analysis and generates analytics results on new application detection.

Step 12: Based on the results from data analytics, the NWDAF 11 notifies the related services consumer(s) the analytics result(s) by invoking a new application detection notification procedure or any other procedure or sends the Nnwdaf_Analyticslnfo_Notify message or any other message to the NEF 14 in order to report/notify analytics results on new application detection. This message includes Notification Correlation Information, and analytics results.

The analytics results include at least one of the following parameters: DNN, S-NSSAI, the list of recommended new PFDs for new applications, the list of recommended new 3-tuple to be added to existing PFDs, and the list of recommended 3-tuple to be deleted from existing PFDs.

The list of recommended new PFDs for new applications includes at least one of the following parameters: 3-tuple(s) including protocol, server side IP address and port number; the significant parts of the URL to be matched, a Domain name matching criteria and information about applicable protocol(s).

The list of recommended new 3-tuple to be added to existing PFDs includes at least one of the following parameters: 3-tuple(s) including protocol, server side IP address and port number; the significant parts of the URL to be matched, a Domain name matching criteria and information about applicable protocol(s).

The list of recommended 3-tuple to be deleted from existing PFDs includes at least one of the following parameters: 3-tuple(s) including protocol, server side IP address and port number; the significant parts of the URL to be matched, a Domain name matching criteria and information about applicable protocol(s).

Notification Correlation Information is a Notification Target Address (+Notification Correlation ID) that allows correlating notifications received from the NWDAF 11 with the service consumer' subscription as described in 3GPP TS 23.288 (NPL 5). Notification Correlation Information can be used instead of analytics ID(s) and analytics filter(s), which are optional parameters in the above message.

Step 13: The NEF 14 assigns a PFD ID for each new PFD and associated it with an application ID. If possible, the NEF 14 contacts the AF to obtain an application ID. Otherwise, the NEF 14 assigns a unique application ID without the AF.

Step 14-16: The NEF 14 informs the UDR 15 to updates the corresponding PFD(s).

Step 17: The NEF 14 notifies its Nnef_PFDManagement service consumer the list of latest PFDs, which is updated based on NWDAF 11's analytics results on new application detection.

The service consumer can be the SMF 13, the OAM, and the AF.

### SUMMARY

Beneficially, the above described aspects include, although they are not limited to, one or more of the following functionalities:

1) In existing scheme, packet inspection is performed in the NWADF 11, which generates massive traffic between the UPF 10 and the NWDAF 11. This leads to increase in the signalling overhead as well as capacity exhaustion of the relevant NFs. In the proposed solutions, packet inspection is performed in the UPF 10, and the UPF 10 only sends the NWDAF 11 the application detection report instead of all the packets. This can significantly reduce the traffic between the UPF 10 and the NWDAF 11.

2) Two new solutions have been proposed to detect new applications. One new solution is that NWDAF 11 defines ADC rule for new application detection, which provides flexibility to the operator to detect any specific application, which facilitate better resource allocation and more accurate charging. The other solution is that PCF 12 defines Application Detection Rules, which take advantages of reverse DNS lookup. In this way, the NWDAF 11 can obtain the URL and the domain name information of a packet from the IP address provided in the non-matching header packet report. Therefore, the UPF 10 doesn't need to send the NWDAF 11 whole application packets in order to extract URL and the domain name from the packets.

3) New parameters search key and search condition have been proposed to be provided for the NWDAF 11 to generate the ADC rule for application detection.

4) Based on new PCC rules on new packet detection, the SMF 13 derives new packet detection rules and usage reporting rules.

5) The UPF 10 performs packet inspection, and generates application detection report based on the new packet detection rules and usage reporting rules.

6) After detecting new packet header, the UPF 10 sends the non-matching packet header report on packets that don't have an application ID and cannot match any packet filter in default QoS flow.

In order to provide these functionalities, the above aspects describe exemplary methods comprising (at least some of) the following steps:

1) The NEF 14 subscribes NWDAF's service to detect new applications.

2) The PCF 12 delivers new application detection related PCC rules to the SMF 13.

3) The SMF 13 instructs the UPF 10 to report packets according to new application detection rule and usage reporting rule.

4) The UPF 10 performs packet inspection and reports the SMF 13 when the reporting criteria is met.

5) The SMF 13 sends the NWDAF 11 the new application detection report.

6) The NWDAF 11 performs data analysis on the new application detection report, and generates analytics results, which derive corresponding PFDs.

7) The NWDAF 11 notifies the NEF 14 its analytics results.

<Benefits>

New methods are proposed to detect new application traffic. By using these solutions, it allows the network to automatically detect new application traffic without causing significant signaling load to the network.

<System Overview>

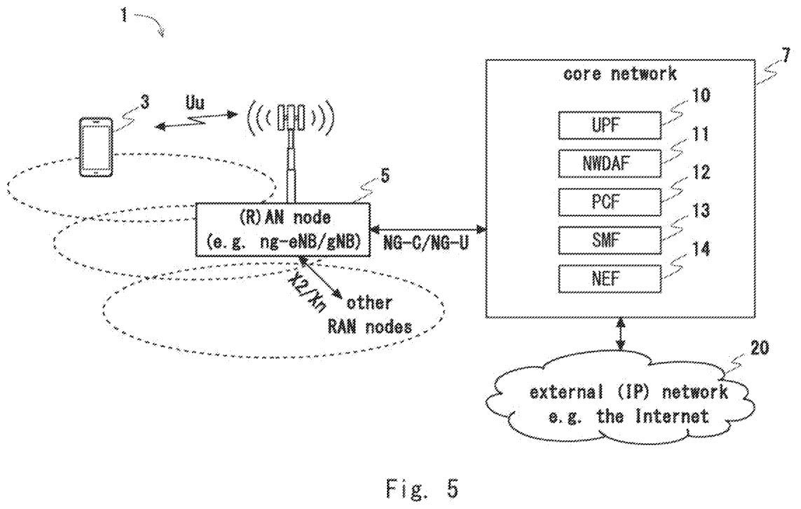

FIG. 5 schematically illustrates a mobile (cellular or wireless) telecommunication system 1 to which the above aspects are applicable.

In this network, users of mobile devices 3 (UEs) can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst one mobile device 3 and one base station 5 (RAN) are shown in FIG. 5 for illustration purposes, the system, when implemented, will typically include other base stations and mobile devices (UEs).

Each base station 5 controls one or more associated cells (either directly or via other nodes such as home base stations, relays, remote radio heads, distributed units, and/or the like). A base station 5 that supports E-UTRA protocols to the mobile devices 3 may be referred to as an ‘ng-eNB’ and a base station 5 that supports Next Generation protocols to the mobile devices 3 may be referred to as a ‘gNB’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘Uu’ interface and/or the like). Neighbouring base stations 5 are connected to each other via an appropriate base station to base station interface (such as the so-called ‘X2’ interface, ‘Xn’ interface and/or the like). The base station 5/access network is also connected to the core network nodes via an appropriate interface (such as the so-called ‘NG-U’ interface (for user-plane), the so-called ‘NG-C’ interface (for control-plane), and/or the like).

The core network 7 typically includes logical nodes (or ‘functions’) for supporting communication in the telecommunication system 1. Typically, for example, the core network 7 of a ‘Next Generation’/5G system will include, amongst other functions, control plane functions (CPFs) and user plane functions (UPFs) 10. It will be appreciated that the core network 7 may also include, amongst others: a Network Data Analytics Function (NWDAF) 11, a Policy Control Function (PCF) 12, a Session Management Function (SMF) 13, and a Network Exposure Function (NEF) 14. Although not shown in FIG. 5, the core network 7 may also be coupled to at least one application function (AF)/application server (AS), and/or the like. From the core network 7, connection to an external IP network/data network 20 (such as the Internet) is also provided.

The components of this system 1 are configured to perform one or more of the above described aspects for data analytics-assisted application detection.

<User Equipment (UE)>

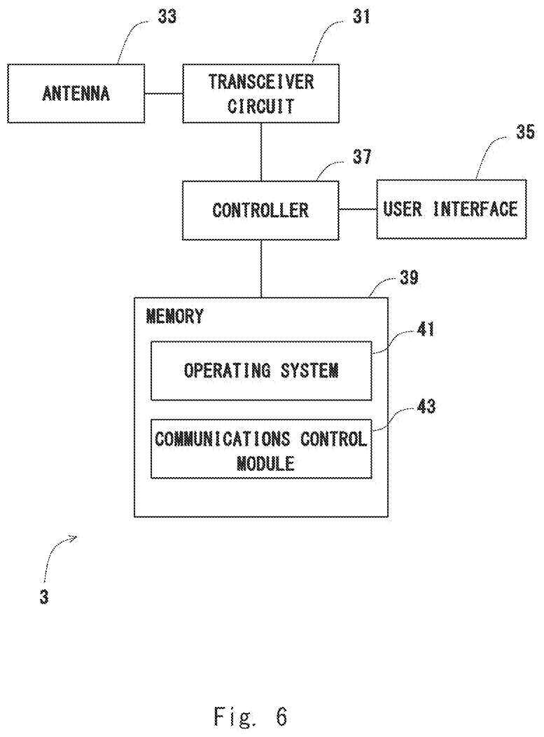

FIG. 6 is a block diagram illustrating the main components of the UE (mobile device 3) shown in FIG. 5. As shown, the UE 3 includes a transceiver circuit 31 which is operable to transmit signals to and to receive signals from the connected node(s) via one or more antenna 33. Although not necessarily shown in FIG. 6, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication system 1 or from a removable data storage device (RMD), for example. The software includes, among other things, an operating system 41 and a communications control module 43. The communications control module 43 is responsible for handling (generating/sending/receiving) signalling messages and uplink/downlink data packets between the UE 3 and other nodes, including (R)AN nodes 5, application functions, and core network nodes. Such signaling includes appropriately formatted requests and responses relating to data analytics-assisted application detection.

<(R)an Node>

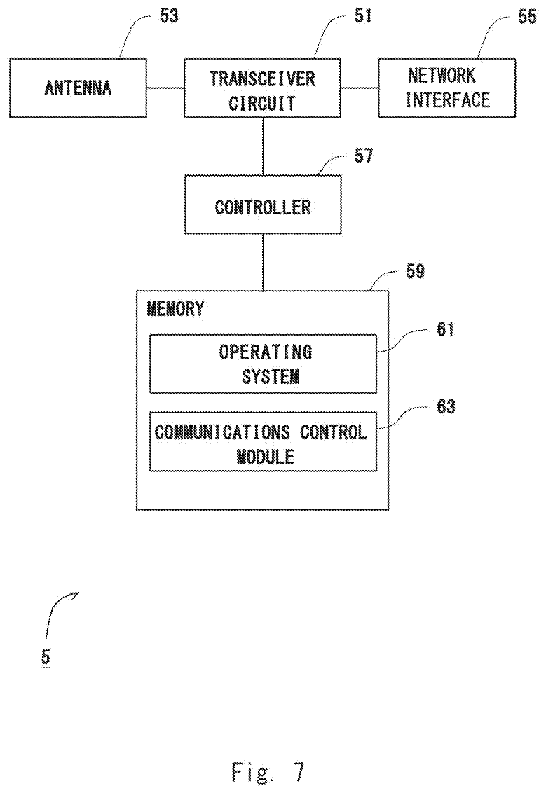

FIG. 7 is a block diagram illustrating the main components of an exemplary (R)AN node 5 (base station) shown in FIG. 5. As shown, the (R)AN node 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as NG-U/NG-C). A controller 57 controls the operation of the (R)AN node 5 in accordance with software stored in a memory 59. The software may be pre-installed in the memory 59 and/or may be downloaded via the telecommunication system 1 or from a removable data storage device (RMD), for example. The software includes, among other things, an operating system 61 and a communications control module 63. The communications control module 63 is responsible for handling (generating/sending/receiving) signalling between the (R)AN node 5 and other nodes, such as the UE 3, and the core network nodes. Such signaling includes appropriately formatted requests and responses relating to data analytics-assisted application detection.

<Core Network Node>

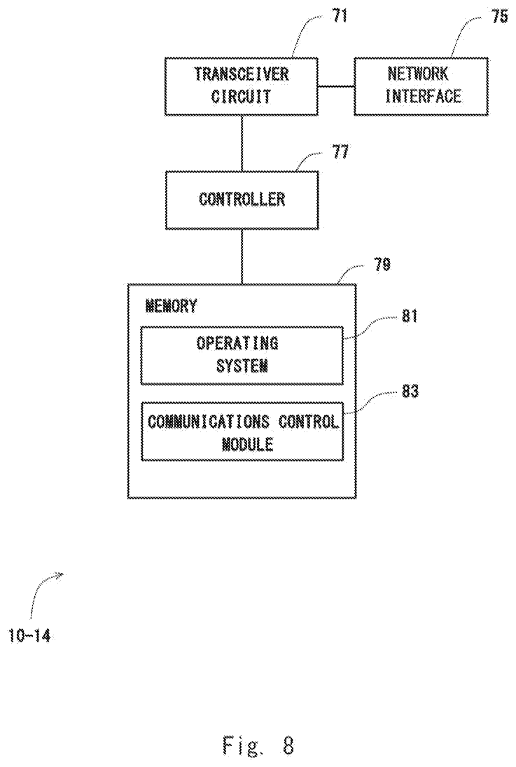

FIG. 8 is a block diagram illustrating the main components of a generic core network node (or function) shown in FIG. 5, for example, the UPF 10, the NWDAF 11, the PCF 12, the SMF 13, and the NEF 14. As shown, the core network node includes a transceiver circuit 71 which is operable to transmit signals to and to receive signals from other nodes (including the UE 3 and the (R)AN node 5) via a network interface 75. A controller 77 controls the operation of the core network node in accordance with software stored in a memory 79. The software may be pre-installed in the memory 79 and/or may be downloaded via the telecommunication system 1 or from a removable data storage device (RMD), for example. The software includes, among other things, an operating system 81 and at least a communications control module 83. The communications control module 83 is responsible for handling (generating/sending/receiving) signaling between the core network node and other nodes, such as the UE 3, (R)AN node 5, and other core network nodes. Such signaling includes appropriately formatted requests and responses relating to data analytics-assisted application detection.

<Modifications and Alternatives>

Detailed aspects have been described above. As those skilled in the art will appreciate, a number of modifications and alternatives can be made to the above aspects whilst still benefiting from the inventions embodied therein. By way of illustration only a number of these alternatives and modifications will now be described.

In the above description, the UE 3, the (R)AN node 5, and the core network node 7 are described for ease of understanding as having a number of discrete modules (such as the communication control modules). Whilst these modules may be provided in this way for certain applications, for example where an existing system has been modified to implement the above aspects, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (TO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3, the (R)AN node 5, and the core network node 7 as a signal over a computer network, or on a recording medium. Further, the functionality performed by part or all of this software may be performed using one or more dedicated hardware circuits. However, the use of software modules is preferred as it facilitates the updating of the UE 3, the (R)AN node 5, and the core network node 7 in order to update their functionalities.

The above aspects are also applicable to ‘non-mobile’ or generally stationary user equipment.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from European provisional patent application No. 20187246.2, filed on Jul. 22, 2020, the disclosure of which is incorporated herein in its entirety by reference.

### REFERENCE SIGNS LIST

1 MOBILE (CELLULAR OR WIRELESS) TELECOMMUNICATION SYSTEM
3 MOBILE DEVICE (UE)
5 BASE STATION ((R)AN NODE)
7 CORE NETWORK
10 USER PLANE FUNCTION (UPF)
11 NETWORK DATA ANALYTICS FUNCTION (NWDAF)
12 POLICY CONTROL FUNCTION (PCF)
13 SESSION MANAGEMENT FUNCTION (SMF)
14 NETWORK EXPOSURE FUNCTION (NEF)
15 USER DATA REPOSITORY (UDR)
20 EXTERNAL IP NETWORK
31 TRANSCEIVER CIRCUIT
33 ANTENNA
35 USER INTERFACE
37 CONTROLLER
39 MEMORY
51 TRANSCEIVER CIRCUIT
53 ANTENNA
55 NETWORK INTERFACE
57 CONTROLLER
59 MEMORY
61 OPERATING SYSTEM
63 COMMUNICATIONS CONTROL MODULE
71 TRANSCEIVER CIRCUIT
75 NETWORK INTERFACE
77 CONTROLLER
79 MEMORY
81 OPERATING SYSTEM
83 COMMUNICATIONS CONTROL MODULE

What is claimed is:

1. A network data analytic function, NWDAF, node, comprising:
one or more memories; and
one or more processors, comprising hardware, configured to:
receive, from a network function node, a request for detecting a new application, including an indication having a value “new application analysis”, information for a User Equipment, UE, start and end time for detection and Packet Flow Description, PFD, information;
subscribe, to a session management function, SMF, node, data collection related to the new application;
receive, from a user plane function, UPF, node via the SMF node, the data related to the new application, including data network name, DNN, single-network slice selection assistance information, S-NSSAI, and 3-tuple(s); and
notify the network function node of an analytic result including the DNN, the S-NSSAI, the 3-tuple(s) to be added to the PFD information, parts of the Unified Resource Locator, URL, to be matched, a Domain name matching criteria and information about applicable protocol(s), wherein
the 3-tuple(s) includes a server side Internet Protocol, IP, address and port number.

2. (canceled)

3. A control method for a network data analytic function, NWDAF, node, comprising:
receiving, from a network function node, a request for detecting a new application, including an indication having a value “new application analysis”, information for a User Equipment, UE, start and end time for detection and Packet Flow Description, PFD, information;
subscribing, to a session management function, SMF, node, data collection related to the new application;
receiving, from a user plane function, UPF, node via the SMF node, the data related to the new application, including data network name, DNN, single-network slice selection assistance information, S-NSSAI, and 3-tuple(s); and
notifying the network function node of an analytic result including the DNN, the S-NSSAI, the 3-tuple(s) to be added to the PFD information, parts of the Unified Resource Locator, URL, to be matched, a Domain name matching criteria and information about applicable protocol(s), wherein
the 3-tuple(s) includes a server side Internet Protocol, IP, address and port number.

4. A control method for a network function node, comprising:
transmitting, to a network data analytic function, NWDAF, node, a request for detecting a new application, including an indication having a value “new application analysis”, information for a User Equipment, UE, start and end time for detection and Packet Flow Description, PFD, information; and
receiving, from the NWDAF node, an analytic result including DNN, S-NSSAI, 3-tuple(s) to be added to the PFD information, parts of the Unified Resource Locator, URL, to be matched, a Domain name matching criteria and information about applicable protocol(s), wherein
the 3-tuple(s) includes a server side Internet Protocol, IP, address and port number, and
data related to the new application including the DNN, the S-NSSAI and the 3-tuple(s) is sent from a user plane function, UPF, node via a session management function, SMF, node, upon subscription of data collection related to the new application from the NWDAF node to the SMF node.
